(19) United States
(12) Patent Application Publication
(10) Pub. No.: US 2025/0069368 A1
(43) Pub. Date: Feb. 27, 2025

(54) Method and a System for Bandwidth-Constrained Cooperative Object Detection

(71) Applicant: The United States of America as represented by the Secretary of the Navy, San Diego, CA (US)

(72) Inventors: Diego Marez, Oceanside, CA (US); Lena Marie Nans, San Diego, CA (US)

(73) Assignee: The United States of America as represented by the Secretary of the Navy, San Diego, CA (US)

(21) Appl. No.: 18/779,669

(22) Filed: Jul. 22, 2024

Related U.S. Application Data
(60) Provisional application No. 63/578,007, filed on Aug. 22, 2023.

(51) Int. Cl. G06V 10/764; G06V 10/24; G06V 10/40; G06V 10/80; G06V 10/82; G06V 20/58

(52) U.S. Cl. CPC G06V 10/764; G06V 10/24; G06V 10/40; G06V 10/806; G06V 10/82; G06V 20/58

(57) ABSTRACT

A method and a system for bandwidth-constrained cooperative object detection. The method for cooperative object detection comprising: providing a backbone architecture for feature extraction with shared weights across a plurality of agents; capturing optical data of a scene of interest at the plurality agents; extracting features at each of the plurality of agents from the optical data with the backbone architecture; compressing the features at each of the plurality of agents with a compression module optimized by a loss function comprising mean squared error of decompression; decoding compressed features from the plurality of agents at a reference platform; fusing the features with an object recognition neural network; and determining a plurality of object bounding boxes and a plurality of object classes.

### STATEMENT REGARDING FEDERALLY-SPONSORED RESEARCH AND DEVELOPMENT

The United States Government has ownership rights in this invention. Licensing inquiries may be directed to Office of Research and Technical Applications Naval Information Warfare Center Pacific, Code 72120, San Diego, CA, 92152; telephone (619) 553-5118; email: niwc_patent.fct@us.navy.mil, referencing Navy Case No. 211,250.

### BACKGROUND

The field of object detection profoundly accelerated alongside developments in computer vision, image processing, and machine learning. Stated simply, object detection works by analyzing image or optical data for recognizable features and classifying them accordingly. This enabled uses in numerous fields including vehicle detection, face detection, image annotation, and more. Similarly, object tracking involves both the detection of the object and continuously following that object over a period of time. This field continues to improve object detection systems and method for the important metrics of accuracy and efficiency.

Further improvements have integrated multiview optical sensors for object detections. This approach fuses views from unique sensors, cameras, angles, and distances to improve feature detection. A particular challenge for object detection is the obfuscation of objects in an image. For example, one could imagine object detection applied to an autonomous car system where the cameras are detecting and tracking surrounding objects. While driving, cars continuously come in and out of view of a single sensor. However, a multiview sensor system would improve continuity as some cameras could see another's blind spot. As this example suggests, more optical and image data may enable substantial improvements in the detection and tracking accuracy.

However, there is a continued need to integrate multiview systems for greater efficiency. Large transmission sizes, object dropout, and maintaining detection precision are critical hurdles for next generation object detection systems.

### SUMMARY

According to illustrative embodiments, a method for cooperative object detection comprising: providing a backbone architecture for feature extraction with shared weights across a plurality of agents; capturing optical data of a scene of interest at the plurality agents; extracting features at each of the plurality of agents from the optical data with the backbone architecture; compressing the features at each of the plurality of agents with a compression module optimized by a loss function comprising mean squared error of decompression; decoding compressed features from the plurality of agents at a reference platform; fusing the features with an object recognition neural network; and determining a plurality of object bounding boxes and a plurality of object classes.

In another embodiment, a method of compressing optical data in a cooperative object detection architecture, the steps comprising: providing a backbone architecture for feature extraction with shared weights across a plurality of agents; receiving optical data from a plurality of agents; extracting features at each of the plurality of agents from the optical data with the backbone architecture; compressing the features at each of the plurality of agents with a compression module optimized by a loss function comprising mean squared error of decompression; decoding compressed features from the plurality of agents at a reference platform; aligning the features with relative pose data to spatially align features collected by the plurality of agents with the reference platform, wherein spatially aligning the features is tuned by an alignment loss function; providing the features to an object recognition neural network.

In another embodiment, a cooperative object detection system, comprising: a plurality of support platforms, further comprising: an optical sensor for capturing optical data, one or more processors that when executing one or more instructions stored in an associated memory are configured to: compress features at each of the plurality of support platforms from the optical data with the backbone architecture, compress the features at each of the plurality of support platforms with a compression module optimized by a loss function comprising mean squared error of decompression, and transmit compressed features to an ego platform, wherein the compressed features are decompressed and aligned; an ego platform comprising: an object recognition neural network for feature fusion; one or more processors that when executing one or more instructions stored in an associated memory are configured to: decode compressed features from the plurality of support platforms an ego platform, fuse the features with an object recognition neural network, and determine a plurality of object bounding boxes and a plurality of object classes.

It is an object to provide a Method and a System for Bandwidth-Constrained Cooperative Object Detection that offers numerous benefits, including enhanced precision, improved accuracy relative to object dropout, and significantly reduced messaged size between agents in a cooperative network.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The accompanying drawings, which are incorporated in and form a part of the specification, illustrate example embodiments and, together with the description, serve to explain the principles of the invention. Throughout the several views, like elements are referenced using like references. The elements in the figures are not drawn to scale and some dimensions are exaggerated for clarity. In the drawings:

FIG. 1 shows an exemplary object detection architecture comprising an ego platform.

FIG. 2 shows a block-diagram illustration of a method for cooperative object detection.

FIG. 3 shows the alignment model configured to the plurality of the decompressed features from the decoder.

FIG. 4 shows a side-by-side comparison of an (a) unaligned feature map and (b) aligned feature map.

FIG. 5 shows an exemplary block diagram of detection network.

FIG. 6 shows a block-diagram illustration of a method of compressing optical data in a cooperative object detection architecture.

FIG. 7 shows a table comprising the results of multiple embodiments of the model.

FIG. 8 shows a graph of dropout percentage vs. the Average mAP (%) for a single detector (baseline), AE+Align, and FP+Align models.

FIG. 9A shows an example of optical data comprising three images of sample images for an automotive application.

FIG. 9B shows an example of box bounding of three exemplary objects of interest.

### DETAILED DESCRIPTION OF EMBODIMENTS

The disclosed system and method below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other system and methods described herein as will be understood by one of ordinary skill in the art unless otherwise stated specifically.

References in the present disclosure to “one embodiment,” “an embodiment,” or any variation thereof, means that a particular element, feature, structure, or characteristic described in connection with the embodiments is included in at least one embodiment. The appearances of the phrases “in one embodiment,” “in some embodiments,” and “in other embodiments” in various places in the present disclosure are not necessarily all referring to the same embodiment or the same set of embodiments.

As used herein, the terms “comprises,” “comprising,” “includes,” “including,” “has,” “having,” or any variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of words such as “the,” “a,” or “an” are employed to describe elements and components of the embodiments herein; this is done merely for grammatical reasons and to conform to idiomatic English. This detailed description should be read to include one or at least one, and the singular also includes the plural unless it is clearly indicated otherwise.

Object detection localizes and classifies objects within image or optical data including, but not limited to, pictures, videos, LiDAR, Radar, and thermal imaging. There are many different architectures used currently for object detection. One notable and exemplary family of architectures are those in the Region-based Convolutions Neural Network (“RCNN”) family. This two-stage object detection process first proposes a region which may contain an object and second classifies the object and refines the proposal region. Detecting objects from signal vantage point presents challenges with distance and obfuscations. Cooperative object detection and multiview camera object detection have attempted to solve these issues by including multiple sensors at different vantage points.

Multiview object detection systems have applications from robotics to security networks. These systems comprise networks of sensors that communicate with each other to aggregate detection data and improve performance. This has reduced the issues with obfuscation and distance and improved detection and resiliency. However, advancements in this field have been throttled by bandwidth limitations, which become important in many situations such as where agents are trying to communicate cheaply and efficiently. For example, self-driving cars and drone swarms benefit greatly from low-bandwidth transmission to carry out cooperative computer visions tasks. Accordingly, there is a need for further work on multi-view object detection architectures.

Object detection architectures utilize a machine learning algorithm to train object detection algorithms, or elements thereof. These algorithms are often cost-prohibitive and challenging to train based on the amount of data required. However, opportunity for innovation has arisen as a result of open datasets such as the University of California's Los Angeles Mobility Lab's OPV2V, which provides a large-scale Open Dataset for Perception with V2V communication. Utilized for testing in the embodiment describe herein, exemplary training data contains 6764/1981/2719 training/validation/test examples for providing a high degree of reliability for the results. UCLA's OPV2V is exemplary dataset that may provide training data to enable the disclosed subject matter, but it is not so limited. The disclosed subject matter may be trained on any data set a skilled artisan would recognize as useful for 3D object detections.

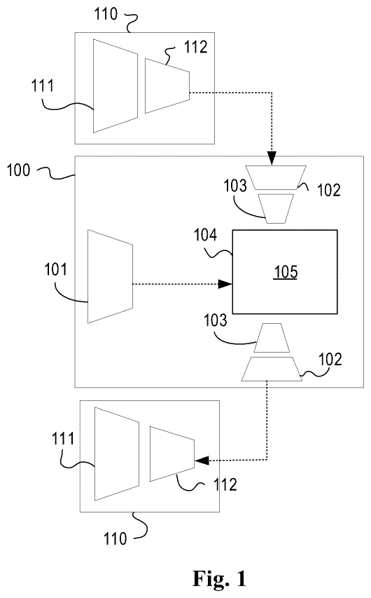

FIG. 1 shows an exemplary object detection architecture comprising an ego platform 100 further comprising a feature extraction module 101, a plurality of decoders 102, a plurality of alignment modules 103, and a feature fusions module 105; and plurality of support platforms 110 further comprising a feature extraction module 111, and an encoder 112. This architecture may utilize optical and/or image data to extract features at the feature extraction module 111. Features comprise information about the optical and/or image data with various levels of complexity. Common examples of features include structural elements such as lines, edges, rides, corners, blobs, and points. Additionally, feature information may comprise more intricate information regarding texture, color, shape, motion, or abstract representations learned by the model. Support platforms 110 may encode 112 features and transmit them to an ego platform 100. Transmission techniques may include, but are not limited to Bluetooth, Wi-Fi, near field, 5G, or similar methods. An ego platform 100 may also have a feature extraction model 101, but primarily fuses the features 104 into an aggregate detection analysis. To fuse the extracted features from the support platforms, the ego platform may further comprise a decoder 102 and an alignment module 103. This architecture is one embodiment of an object detection system that provides a more precise, robust, and reliable results than existing architectures.

The architecture described above may utilize a cooperative object detection model for image processing, compression, alignment, and detections. These functions are all supported by a backbone network that has shared weights distributed across all platforms in the ecosystem of the agents. The weighting system provides a value to each feature based on its dot product, where the sum of all weights is equal to 1. This technique allows for optical data with a better view, angle, etc. . . . to more heavily influence the final transposition. Ultimately, the backbone allows all the distributed agents to contribute to a single feature map with advantage of many more angles and perspectives.

In one embodiment, the backbone network may be MobileNetV3 Large, which is capable for taking images from a plurality of support platform in the vicinity of an ego platform.

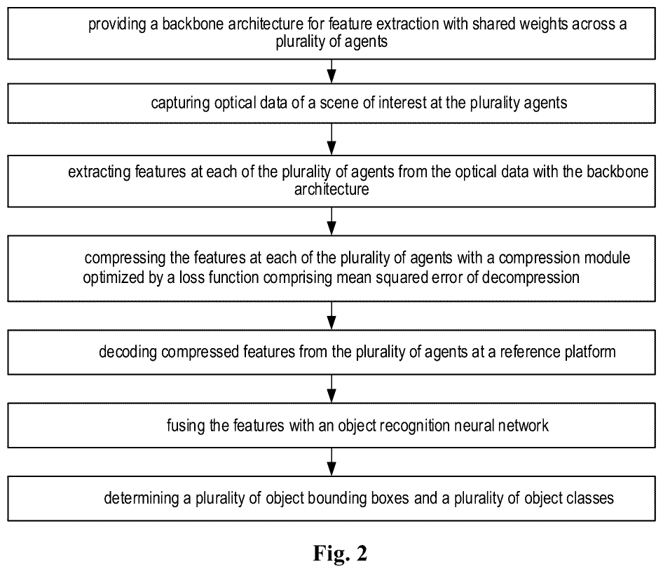

FIG. 2 shows a block-diagram illustration of a method for cooperative object detection, the steps comprising: providing a backbone architecture for feature extraction with shared weights across a plurality of agents; capturing optical data of a scene of interest at the plurality agents; extracting features at each of the plurality of agents from the optical data with the backbone architecture; compressing the features at each of the plurality of agents with a compression module optimized by a loss function comprising mean squared error of decompression and (optional) rate loss; decoding compressed features from the plurality of agents at a reference platform using a module optimized by an alignment loss; fusing the features with an object recognition neural network; and determining a plurality of object bounding boxes and a plurality of object classes. This method may be deployed to any cooperative or multi-view object recognition system comprising a plurality of agents configured to capture optical data. Additionally, this method may adapt to fuse optical data from a plurality of agents capturing a scene of interest. Specifically, the fusing model automatically adjusts to the number of platforms present.

The method for cooperative object detection utilizes machine-learning to enhance the compression and feature identification capabilities. To measure such improvements, industry-standard evaluation metrics may be applied to the model. One exemplary evaluation metrics that may be applied is the MS-COCO style detection metrics for computing mean average precision (mAP). In order to calculate the mAP score, the AP (average precision) is computed at 11 different intersection over union thresholds [0.50, 0.55, . . . 0.95] and then averaged across classes. One embodiment of the disclosed subject matter is evaluated as such to demonstrate the described improvements.

Improvements to efficiency and performance for object detection may be achieved with compression models. In one embodiment, the compression model is Factor Prioritized (FP). In the FP model, once an initial image passes through the backbone feature extractor of the network, there are two different behaviors depending on the role of the platform (i.e. whether the platform is transmitting or receiving the data). If a platform is transmitting the information, the features from those backbones are synthesized and encoded using the first half of a compression network. The underlying model may rely on a learned factorized prior model. In an exemplary use case, embodiments refer to models using Ball'e et al.'s methods to compress data as Factorized Prior (FP) models. If a platform is the receiving (ego) platform, then it does not encode its own feature map. The ego platform will decode any received information with an analysis portion of the compression network and that information is combined with its own feature map.

In another embodiment, the compression model may be Autoencoder (AE). For the autoencoder model, the features are compressed using 1×1 convolutions to change the number of input channels while maintaining the same spatial dimensions. Functionally, the agent would extract features from the inputs and then map those features to the latent space. That latent mapping can be sent to other agents which then use the decoding half of the autoencoder to increase the resolution of the features. For the compression loss, embodiments simply use the distortion loss of Equation (2). This loss function gauges the discrepancies between condensed information and non-condensed information.

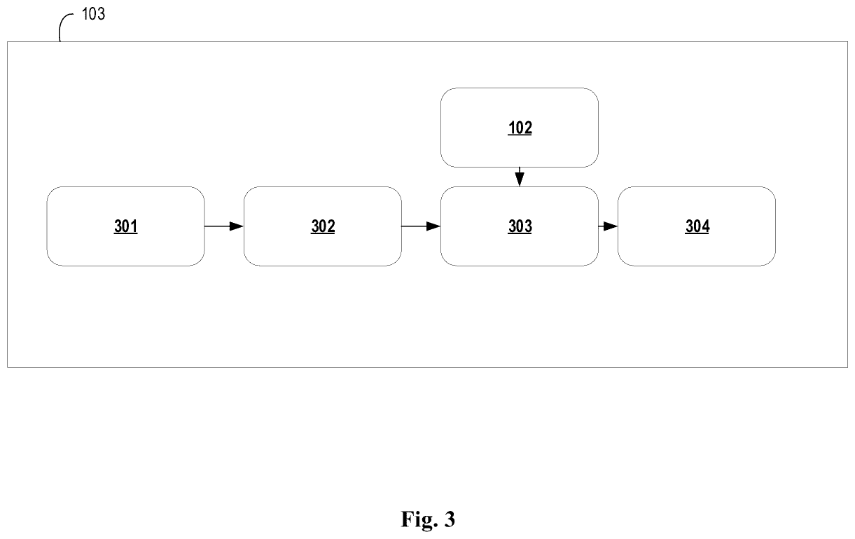

FIG. 3 shows one embodiment of alignment model 103 configured to the plurality of the decompressed features from the decoder 102 and may comprise, consist, or consist essentially of a support platform relative pose data 301, multi-layer perceptron 302, warp 303, decoder 102, and aligned features 304. The relative pose data 301 is represented as a quaternion for the rotation and the translation is normalized by the maximum communication range. Overall, the pose is fed into the network as a 7-dimensional vector at the multi-layer perception module 302. Then the module processes it through a fully connected network. Next, it outputs an affine transform which is used to warp the support platform features in order to improve the alignment with the local ego features.

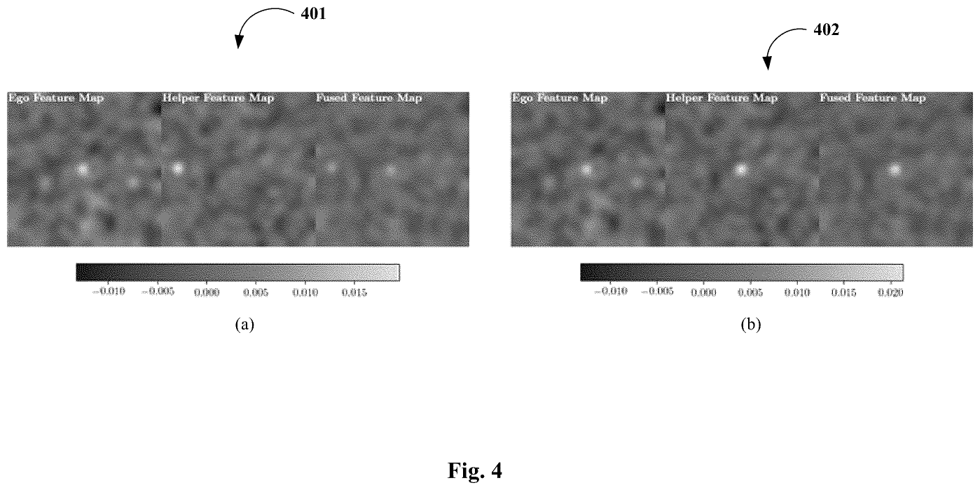

FIG. 4 shows an exemplary side-by-side comparison of an (a) unaligned feature map 401 and (b) aligned feature map 402. The features in FIG. 4 are examples sourced from a dataset comprising groups of images from completely different angles in a scene. Here, each platform extracts unique features depending on its placement and orientation. The alignment model receives the relative placement and orientation information between the ego platform and the support platform. As shown in FIG. 4, when the features are misaligned, the overall intensity of the features may destructively interact. The unaligned features in (a)'s “Ego Feature Map” and “Helper Feature Map” are represented as bright spots that when fused in the “Fused Feature Map” are less intense. As otherwise shown in (b), features will reinforce one another while the surrounding noise will dampen when the intensities align. After the features are aligned, they may be fused by a feature fusion module. Accordingly, this alignment improve precision in the cooperative object identification module.

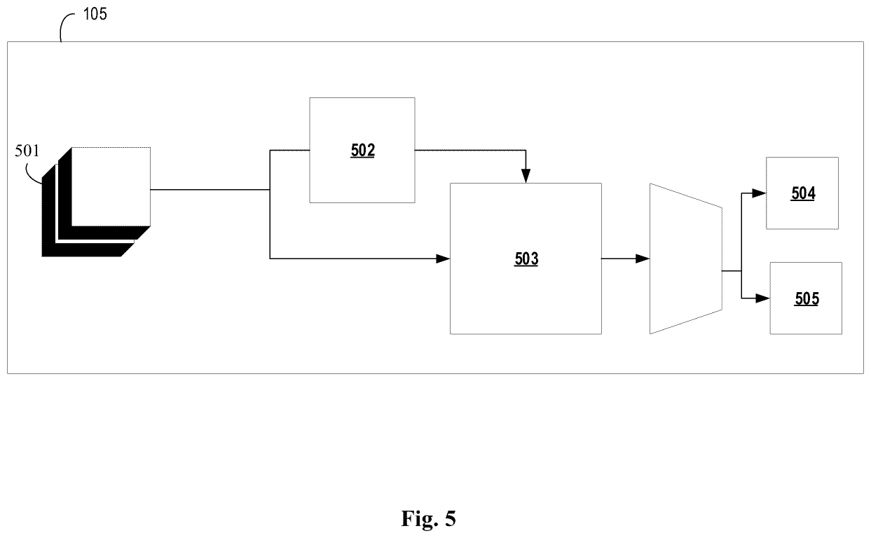

FIG. 5 shows an exemplary block diagram of detection network 105 comprising a feature fusion module 501, region proposal network 502 region of interest pooling 503, bounding boxes 504, and classes 505. The region of interest pooling 503, bounding boxes 504, and classes 505 may be a part of the Faster RCNN Head, the existing object detection framework. However, this object detection framework is merely exemplary and other models may also be used. For example, frameworks in the YouOnlyLooksOnce series, Detectrion2, EfficientDet, MobileNet, Single Shot MultiBox Detector, Mask R-CNN, RetinaNet, CenterNet, Cascade R-CNN, Vision Transformer Networks or similar. Functionally, the detection network receives the formerly compressed and, in some embodiments, aligned feature data and may include aligning the features with relative pose data to spatially align features collected by the plurality of agents with the reference platform.

The feature fusion module 501 may further comprise an attentive layer configured to perform attentive fusion. A self-attentive layer may fuse the decompressed features from the support platforms with the local features of the ego platform. Typically, the self-attentive layer assumes that the features from other platforms are aligned, which is not the case in the image domain. Similar to attention, the self-attentive layer outputs a convex combination of the input features from the platforms at a particular spatial location. Unlike existing self-attentive layer, some embodiments of the instant attentive fusion layer may further comprise convolutional layers to the query, key, and value portions of the self-attentive layer. In doing so, this addition helps to add trainable parameters to the attentive layer portions of the network which gives the fusion model more expressivity.

To properly calibrate the cooperative object identification model, an alignment loss function needs to account for all the tasks. The loss function (i.e. error function) quantifies the difference between the predicted outputs of a machine learning algorithm and the actual target values. Here, the loss function assumes the following form for the factorized prior models:

$$ℒ ( θ ) = {ℒ}_{detection} ( θ ) + {λ}_{c} ( R ( θ ) + 25 {5}^{2} {λ}_{d} D ( θ ) ) + {λ}_{a} {ℒ}_{a l i g n} ( θ ) \qquad ( 1 )$$

In equation 1, L_{detection} is the standard loss used to train Faster R-CNN in Torchvision (an exemplary use case herein), R is the code rate which controls the level of compression, D is the mean squared error between decompressed feature map and initial feature map, L_{align} is the mean [symbol] ₁ loss between the aligned feature map from the support platform and the local features of the ego platform and θ are the network parameters. The [symbol] ₁ loss was selected for the alignment error because of its robustness to potential outliers yielded by alignment artifacts.

For the autoencoder models, the loss function is simply:

$$ℒ ( θ ) = {ℒ}_{detection} ( θ ) + {λ}_{d} D ( θ ) + {λ}_{a} {ℒ}_{a l i g n} ( θ ) \qquad ( 2 )$$

This loss excludes the distortion loss term because embodiments do not need to account for compression distortion in this network. Loss is a critical component of a cooperative object identification model because allows for the assessment of accuracy. When loss is at a minimum, the model has been optimized for the given use case.

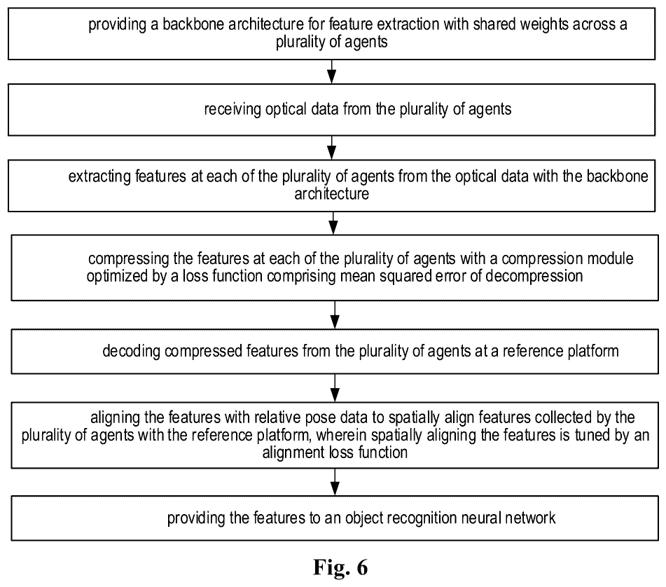

FIG. 6 shows a block-diagram illustration of a method of compressing optical data in a cooperative object detection architecture, the steps comprising: receiving optical data from a plurality of agents; extracting features at each of the plurality of agents from the optical data with: the backbone architecture; compressing the features at each of the plurality of agents with a compression module optimized by a loss function comprising mean squared error of decompression; decoding compressed features from the plurality of agents at a reference platform; aligning the features with relative pose data to spatially align features collected by the plurality of agents with the reference platform; and providing the features to an object recognition neural network.

The method of compressing optical data in a cooperative object detection architecture may be utilized within a model which is physically instantiated at encoder or decoder modules. The encoder and decoder may each utilize the machine learning neural network to share a weight distribution for the feature maps so that the information needed to transmit is minimal.

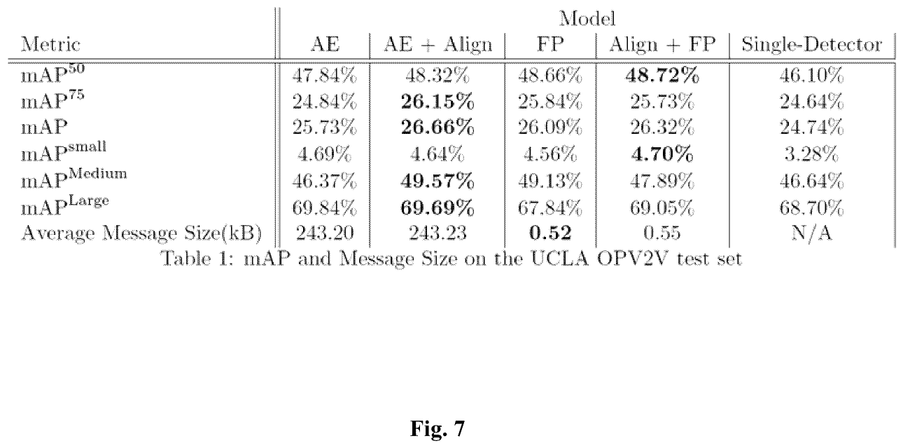

FIG. 7 shows a table comprising the results of multiple embodiments of the model, which compares five different models and their mean average performance (mAP). The models were Autoencoder without alignment, Autoencoder with alignment, Factor Prioritized without alignment, Factor Prioritized with alignment, and a single-detector (baseline). These five models were measured against metrics mAP, mAP at an intersection over union threshold of 50 (“mAP⁵⁰”), mAP⁷⁵, mAP for small objects (“mAP^{small}”), mAP^{medium}, mAP^{large}, and average message size (kB). These results are embodiments of the system and method described herein and do not limit the scope of the subject matter.

As shown in FIG. 7, there is an increase in mean average precision across all evaluation metrics with respect to the single detector baseline. Interestingly, embodiments also see that even without alignment, simply providing information from other platforms close-by begins to increase the mean average precision of detections. The best model without alignment (FP) improves over the single detector model by 1.35%. The autoencoder as well as the factorized prior models (with and without feature alignment) improved upon the capabilities of the baseline.

Adding the alignment aids in making more accurate detections since the mAP score increases by 1.92% over the single detector relative to the best performing model (AE+Align) and the mAP score increases by 0.59% over the best non-alignment cooperative model (FP). When compared to the AE without alignment, the AE with alignment saw the best improvements in all categories except the small object category. The FP+Align model improved over the FP model in terms of mAP only suffering minor degradation in performance for mAP 75 and mAP medium. This demonstrates the power of both using features from other agents as well as spatially transforming those features for the autoencoder network. The FP+Align model saw smaller gains in performance relative to the FP model. With variable and highly disparate positions between sensors and the smaller message sizes it might be difficult for the FP+Align model to take full advantage of the alignment module.

Overall feature alignment yielded improvements to the performance for both FP and AE models in terms of overall mAP and some of the other metrics. All cooperative models had improvements in the small object detection despite not explicitly using multi-scale features such as those used in FPN39 which highlights one of the utilities of multiple vantage points.

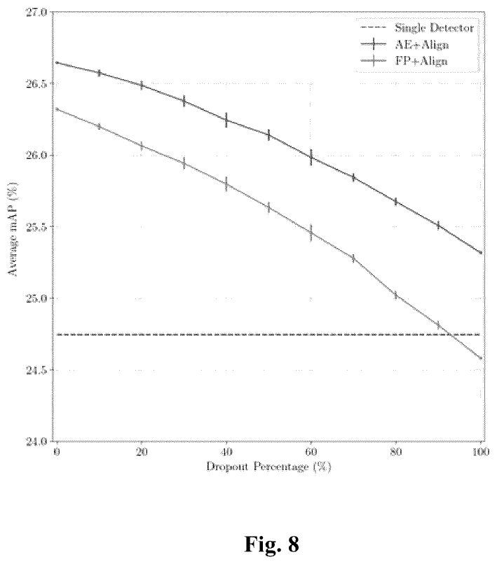

FIG. 8 shows a graph of dropout percentage vs. the Average mAP (%) for a single detector (baseline), AE+Align, and FP+Algin models. In real-world situations, sensor data might not always arrive to the ego car due to lossy communication. Thus, aside from the varying number of cars present during training, one must account for random platforms dropout as well. The test from FIG. 8 shows how different dropout probabilities will affect the overall mean average precision of the detection model. The figure shows both the AE with aligned features as well as the FP with aligned features. In this experiment, embodiments simulated the dropout probabilities at intervals of ten percent.

From this data, the FP model generally retains the same or better performance relative to a single detector until the ninety percent dropout mark. Meanwhile, the AE model retains the better performance even with just the ego car's information. Thus, this test shows us how more contributing agents can boost the mAP of our detector and how gracefully our models' performances decay to roughly the performance of the single detector. With a varying list of support cars, the AE and the FP models are primed to handle random dropouts that can derive from technical difficulties as well as cars simply driving in and out of range from the ego agent.

In one embodiment, a cooperative object detection system may comprise, consist, or consist essentially of a plurality of support platforms, further comprising: an optical sensor for capturing optical data, one or more processors that when executing one or more instructions stored in an associated memory are configured to: compress features at each of the plurality of support platforms from the optical data with the backbone architecture, compress the features at each of the plurality of support platforms with a compression module optimized by a loss function comprising mean squared error of decompression, and transmit compressed features to an ego platform, wherein spatially aligning the features is tuned by an alignment loss function; an ego platform comprising: an object recognition neural network for feature fusion; one or more processors that when executing one or more instructions stored in an associated memory are configured to: decode compressed features from the plurality of support platforms an ego platform, fuse the features with an object recognition neural network, and determine a plurality of object bounding boxes and a plurality of object classes.

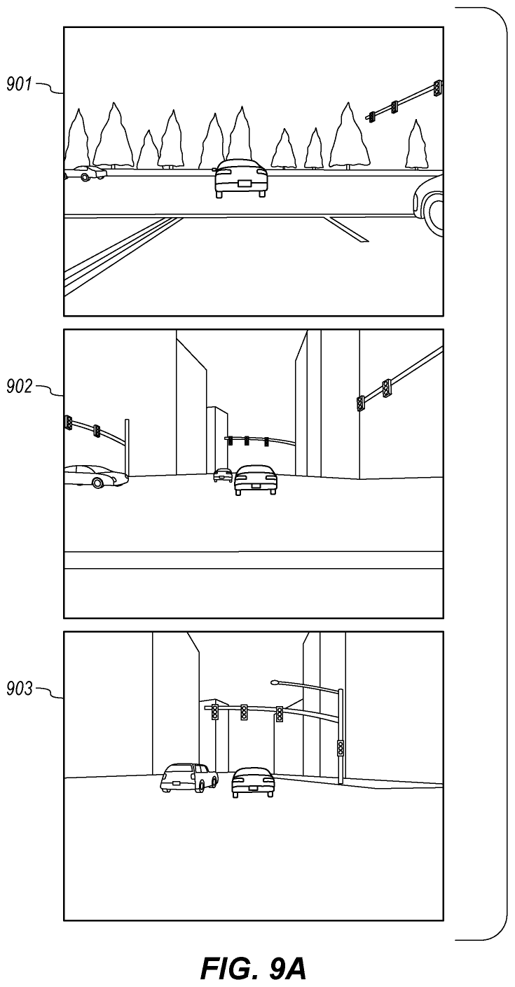

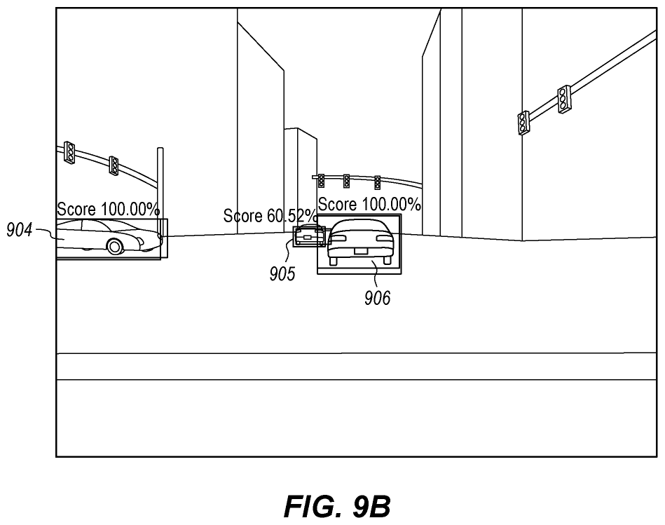

In one embodiment, the platform may be a vehicle network comprising support vehicles and an ego vehicle. In one embodiment, the vehicle network may be network of automobiles. In FIGS. 9A and 9B, embodiments show example detection results for varying numbers of support vehicles for all the test models. FIG. 9A shows an example of optical data comprising three images of sample images 901, 902, and 903 for an automotive application. FIG. 9B shows an example of box bounding of objects of interest 904, 905, and 906.

These exemplary tests illustrate that embodiments can retain or even improve performance even while significantly decreasing the message size that is transmitted from agent to agent. Models with factorized prioritization may reduce the average size of transmission to approximately 0.2% of its original size. The trained compression aspect of this network helps to boost performance since the compression model is trained jointly with the object detection model which helps preserve features that are beneficial to object detection during the compression stage. Under the data rates achievable of 27 Mbps at the range of 300 m under V2V settings, 40 the average FP model message would take approximately 0.16 ms and the average message for the AE model would take approximately 72.06 ms to process.

From the above description of A Method a System for Bandwidth-Constrained Cooperative Object Detection, it is manifest that various techniques may be used for implementing the concepts of a method for cooperative object detection, a method of compressing optical data in a cooperative object detection architecture, and a cooperative object detection system without departing from the scope of the claims. The described embodiments are to be considered in all respects as illustrative and not restrictive. The method and system disclosed herein may be practiced in the absence of any element that is not specifically claimed and/or disclosed herein. It should also be understood that a method for cooperative object detection, a method of compressing optical data in a cooperative object detection architecture, and a cooperative object detection system are not limited to the particular embodiments described herein, but is capable of many embodiments without departing from the scope of the claims.

What is claimed:

1. A method for cooperative object detection, the steps comprising:
providing a backbone architecture for feature extraction with shared weights across a plurality of agents;
capturing optical data of a scene of interest at the plurality agents;
extracting features at each of the plurality of agents from the optical data with the backbone architecture;
compressing the features at each of the plurality of agents with a compression module optimized by a loss function comprising mean squared error of decompression;
decoding compressed features from the plurality of agents at a reference platform;
fusing the features with an object recognition neural network; and
determining a plurality of object bounding boxes and a plurality of object classes.

2. The method for cooperative object detection of claim 1, further comprising the step of:
aligning the features with relative pose data to spatially align features collected by the plurality of agents with the reference platform, wherein spatially aligning the features is tuned by an alignment loss function.

3. The method for cooperative object detection of claim 1, wherein the reference platform further comprises a reference agent for extracting reference features, and further comprising the step of:
fusing the reference features with the compressed features.

4. The method for cooperative object detection of claim 1, wherein the compression module further comprises factorized prioritization.

5. The method for cooperative object detection of claim 4, wherein the factorized prioritization reduces average size of transmission to approximately 0.2% of its original size.

6. The method for cooperative object detection of claim 1, wherein the compression module further comprises autoencoder compression.

7. A method of compressing optical data in a cooperative object detection architecture, the steps comprising:
providing a backbone architecture for feature extraction with shared weights across a plurality of agents;
receiving optical data from a plurality of agents;
extracting features at each of the plurality of agents from the optical data with the backbone architecture;
compressing the features at each of the plurality of agents with a compression module optimized by a loss function comprising mean squared error of decompression;
decoding compressed features from the plurality of agents at a reference platform;
aligning the features with relative pose data to spatially align features collected by the plurality of agents with the reference platform, wherein spatially aligning the features is tuned by an alignment loss function; and
providing the features to an object recognition neural network.

8. The method of compressing optical data in a cooperative object detection architecture of claim 7, wherein the compression module further comprises factorized prioritization.

9. The method of compressing optical data in a cooperative object detection architecture of claim 7, wherein the compression module further comprises Autoencoder compression.

10. The method of compressing optical data in a cooperative object detection architecture of claim 7, wherein at least one a plurality of agents is associated with a stationary optical sensor configured to capture a scene of interest with a surveillance system.

11. The method of compressing optical data in a cooperative object detection architecture of claim 7, wherein at least one a plurality of agents is associated with support vehicle and at least one a plurality of agents is associated with ego vehicle.

12. A cooperative object detection system, comprising:
a plurality of support platforms, further comprising:
an optical sensor for capturing optical data, one or more processors that when executing one or more instructions stored in an associated memory are configured to:
compress features at each of the plurality of support platforms from the optical data with the backbone architecture,
compress the features at each of the plurality of support platforms with a compression module optimized by a loss function comprising mean squared error of decompression, and
transmit compressed features to an ego platform, wherein the compressed features are decompressed and aligned;
an ego platform comprising:
an object recognition neural network for feature fusion;
one or more processors that when executing one or more instructions stored in an associated memory are configured to:
decode compressed features from the plurality of support platforms an ego platform,
fuse the features with an object recognition neural network, and
determine a plurality of object bounding boxes and a plurality of object classes.

13. The cooperative object detection system of claim 12, the ego platform further comprising an ego optical sensor for capturing optical data, and wherein one or more processors that when executing one or more instructions stored in an associated memory are further configured to:
extract features from the ego optical sensor.

14. The cooperative object detection system of claim 12, wherein at least one a plurality of support platforms is a vehicle and the ego platform is a vehicle.

15. The cooperative object detection system of claim 12, wherein at least one a plurality of support platforms is a drone and the ego platform is a drone.

16. The cooperative object detection system of claim 12, wherein at least one a plurality of support platforms is a stationary surveillance system.

17. The cooperative object detection system of claim 12, wherein the ego platform is further configured to:
align the features with relative pose data to spatially align features collected by the plurality of agents with the reference platform, wherein spatially aligning the features is tuned by an alignment loss function.

18. The cooperative object detection system of claim 12 wherein the compression module further comprises factorized prioritization.

19. The cooperative object detection system of claim 18, wherein the factorized prioritization reduces average size of transmission to approximately 0.2% its original size.

20. The cooperative object detection system of claim 12, wherein the compression module further comprises autoencoder compression.
